(19) United States
(12) Patent Application Publication
(10) Pub. No.: US 2015/0199968 A1
(43) Pub. Date: Jul. 16, 2015

(54) AUDIO STREAM MANIPULATION FOR AN IN-VEHICLE INFOTAINMENT SYSTEM

(71) Applicant: CloudCar Inc., Los Altos, CA (US)

(72) Inventors: Abhishek Singhal, Santa Clara, CA (US); Zarko Draganic, Belvedere, CA (US)

(73) Assignee: CloudCar Inc., Los Altos, CA (US)

(21) Appl. No.: 14/156,558

(22) Filed: Jan. 16, 2014

(51) Int. Cl. G10L 17/22; G10L 15/08; G01C 21/36

(52) U.S. Cl. CPC G10L 17/22; G01C 21/3629; G10L 15/08

(57) ABSTRACT

Systems and methods pertaining to an audio stream manipulation system for manipulating an audio stream for an in-vehicle infotainment system are disclosed. A particular embodiment includes: receiving an audio stream via a subsystem of a vehicle; scanning the audio stream, by use of a data processor, to extract keywords, keyword phrases, or acoustic properties; using the extracted keywords, keyword phrases, or acoustic properties to classify audio segments of the audio stream as content segments, advertising (ad) segments, or functional segments; substituting, by use of the data processor, at least one audio segment of the audio stream with a new audio segment to generate a modified audio stream in real time; and causing the modified audio stream to be rendered for a user.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2014, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to an audio stream manipulation system for manipulating an audio stream.

### BACKGROUND

An increasing number of vehicles are being equipped with one or more independent computer and electronic processing systems. Certain of the processing systems are provided for vehicle operation or efficiency. For example, many vehicles are now equipped with computer systems for controlling engine parameters, brake systems, tire pressure and other vehicle operating characteristics. Additionally, other processing systems may be provided for vehicle driver or passenger comfort and/or convenience. For example, vehicles commonly include navigation and global positioning systems and services, which provide travel directions and emergency roadside assistance, often as audible instructions in an audio stream. Vehicles are also provided with multimedia entertainment systems that may include sound systems, e.g., satellite radio receivers, AM/FM broadcast radio receivers, compact disk (CD) players, MP3 players, video players, smartphone interfaces, and the like. These electronic in-vehicle infotainment (IVI) systems can provide digital navigation, information, and entertainment to the occupants of a vehicle, often as audio streams. The IVI systems can also provide a way to listen to radio broadcasts and other audio streams from a variety of sources.

Advertisers make use of these radio broadcasts and audio streams to present advertisements (ads) to the listening public. However, these ads are generic and untargeted, because the advertisers don't have any specific details related to the current listeners of their ads. For example, advertisers don't have access to demographic and/or psychographic profiles of particular listeners being exposed to the audio ads. As a result, the ads may not reach the appropriate audience in an effective manner. Thus, these audio ads can be only marginally successful. Additionally, these advertisements do not provide any mechanism to take an action on the advertisement (e.g., call a vendor or send an e-mail to a merchant).

Functional devices, such as navigation and global positioning systems (GPS), are often configured by manufacturers to produce audible instructions for drivers in the form of functional audio streams that inform and instruct a driver. However, these devices produce generic and untargeted functional audio streams, because the manufacturers don't have any specific details related to the current users of their devices. As a result, the operation of these functional devices cannot be tailored to particular users.

### BRIEF DESCRIPTION OF THE DRAWINGS

The various embodiments are illustrated by way of example, and not by way of limitation, in the figures of the accompanying drawings in which:

FIG. 1 illustrates a block diagram of an example ecosystem in which an in-vehicle infotainment system and an audio stream manipulation module of an example embodiment can be implemented;

FIG. 2 illustrates the components of the audio stream manipulation module of an example embodiment;

FIG. 3 illustrates the composition of an example audio stream and the identification of call-to-action elements performed by the audio stream manipulation module of an example embodiment;

FIGS. 4 and 5 illustrate the composition of an example audio stream and the substitution of advertising (ad) segments performed by the audio stream manipulation module of an example embodiment;

FIGS. 6 and 7 illustrate the composition of an example audio stream and the substitution of content segments performed by the audio stream manipulation module of example embodiment;

FIGS. 8 and 9 illustrate the composition of an example audio stream and the substitution of functional segments performed by the audio stream manipulation module of an example embodiment;

FIG. 10 is a processing flow chart illustrating an example embodiment of systems and methods for providing an audio stream manipulation system liar manipulating an audio stream; and

FIG. 11 shows a diagrammatic representation of machine in the example form of a computer system within which a set of instructions when executed may cause the machine to perform any one, or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

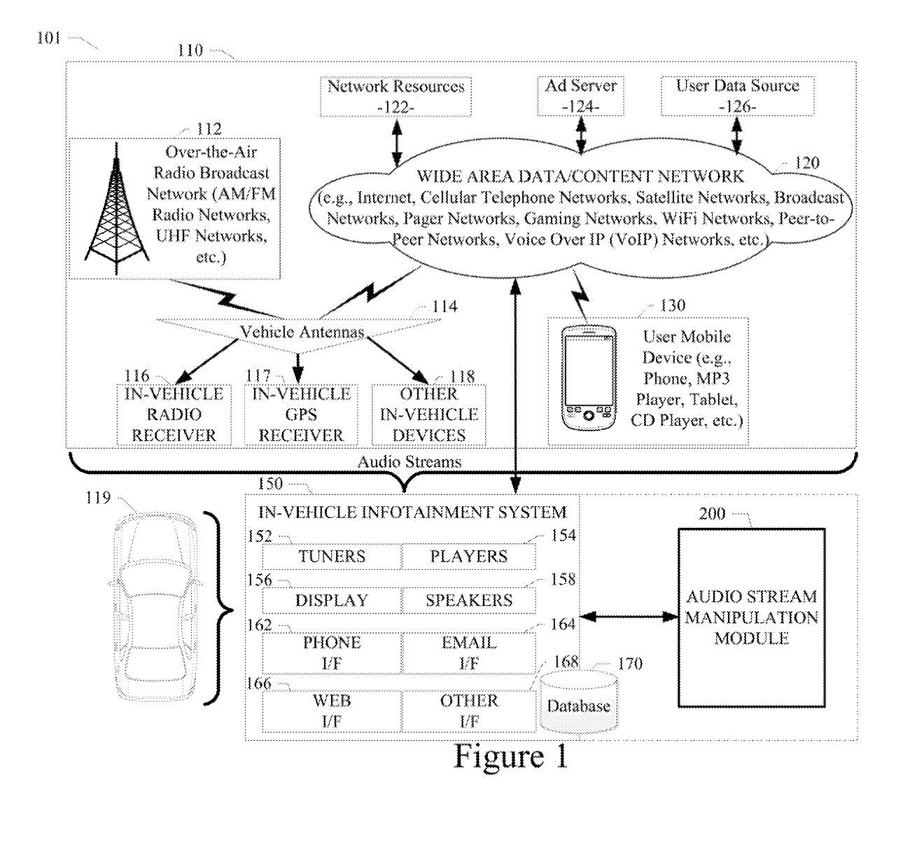

As described in various example embodiment, systems and methods pertaining to an audio stream manipulation module for manipulating an audio stream for an in-vehicle infotainment system are described herein. In one example embodiment, the in-vehicle infotainment system with an audio stream manipulation module can be configured like the architecture illustrated in FIG. 1. However, it will be apparent to those of ordinary skill in the art that the audio stream manipulation module described and claimed herein can be implemented, configured, and used in a variety of other applications and systems as well.

In an example embodiment, an in-vehicle infotainment system with an audio stream manipulation module includes a receiver for receiving a plurality of audio streams from a variety of sources, including an over-the-air radio broadcast, audio streams from proximate mobile devices, audio streams from network cloud-based sources, or audio streams from a vehicle-resident radio receiver, an in-vehicle global positioning system (GPS) receiver or navigation system, or other in-vehicle device that produces or distributes an audio stream. The received audio streams can be standard radio broadcasts or other standard audio streams that do not need to include any markers, codes, or special embedded data. The presently disclosed embodiments do not require special markers, codes, or embedded data. The received audio streams can include standard programming content, such as music, news programming, talk radio, or the like (denoted herein as content segments), advertising segments or clips (denoted herein as advertising segments or ad segments), and/or functional audio, such as the audio instructions produced by a vehicle navigation system or other vehicle subsystem (denoted herein as functional segments). The audio stream manipulation module of an example embodiment processes a received audio stream through a scanner module that performs speech or text recognition on the audio stream using standard speech recognition technology. The speech/text analysis performed on the audio stream can produce keywords and keyword phrases present in the audio stream. The keywords and keyword phrases found in the audio stream can be compared with a library of keywords and keyword phrases known to be included in or indicative of radio advertising. For example, such keywords and keyword phrases might include the names of merchants or products, phone numbers, websites, links, hashtags, or email addresses, and the like associated with radio advertising. The radio advertising related keywords and keyword phrases can be used to identify advertising (ad) segments in the audio stream. In other embodiments, the keywords and keyword phrases found in the audio stream can be compared with a library of keywords and keyword phrases known to be included in or indicative of elements of functional content. Optionally, audio stream keyword phrases can be matched against known text stream(s) of advertisements. For example, such keywords and keyword phrases might correspond to portions of an audio instruction from a navigation device (e.g., “turn left at Maple Street in 500 feet). Portions or segments of an audio stream may also comprise programming content, such as music, news programming, talk radio, or the like (denoted herein as content segments). The ad segments, functional segments, and/or content segments in the audio stream (denoted audio stream segments or audio segments) can also be identified using other hints, such as changes in pitch or volume, gaps in the broadcast, the timing of the broadcast, or knowledge of the patterns of particular broadcasters. Using combinations of the identified keywords/keyword phrases and other related information, audio stream segments can be identified in real-time. The timing associated with the identified audio stream segments (e.g., the start time, end time, duration, etc.) can also be recorded. Given the identified audio stream segments present in the audio stream, a variety of operations can be performed with or on the audio stream segments. A few example operations are set forth below:

1) The content of the identified audio stream segments can be analyzed to determine if there is any call-to-action content in the ad segments of the audio stream. Call-to-action content corresponds to keywords or keyword phrases that prompt a listener to take some action, such as call a phone number, visit a website, send a text message, drive to a location, or the like. When a call-to-action element in an ad segment is identified, the audio stream manipulation module can trigger various types of notifications to invite or prompt the user to respond to the call to action in a variety of ways. For example, the audio stream manipulation module can cause system elements to automatically dial a phone number extracted from the ad segment, automatically send an email to an email address extracted from the ad segment, bookmark or pin a webpage link extracted from the ad segment, send a text message to a phone number extracted from the ad segment, send a tweet, or otherwise communicate with a third party in response to the call-to-action element from the ad segment identified in the audio stream. The notifications can be configured to occur automatically or in response to user prompts. Because the call-to-action element in the ad segment identified in the audio stream can be detected in real time, the timing of the call-to-action in the audio stream can be synchronized with the prompted user action associated with the call-to-action. The audio stream manipulation module can also log the user actions taken in response to the calls-to-action in the audio stream to record the effectiveness of the calls-to-action. This call-to-action logging is described in more detail below in connection with Call-to-Action Logging module 215.

2) An identified ad segment in the audio stream can be replaced with a different ad segment served from an ad server 124 (see FIG. 1) associated with the audio stream manipulation module. The audio stream manipulation module has access to a user's profile and a user's behavioral information, which allows the audio stream manipulation module to ascertain user affinity. User profile and behavioral information can be obtained from user data sources 126 via network 120 in conventional ways. Given knowledge of user affinity, the ad server 124 can be used to retrieve ads that are relevant to the particular user's affinity and the particular user's current context (e.g., location, destination, time, product/service preferences, etc.). One or more of these relevant, user-targeted ads can be configured as an ad segment and substituted into the audio stream in real time to produce a modified audio stream that contains audible advertising customized for the particular user. For example, an audio stream might be originally produced and broadcast to a user system with an advertisement featuring a Cadillac® automobile for sale. The audio stream manipulation module in the user system can obtain access to the users profile and behavioral information. The user's affinity as inferred from the user's profile and behavioral information might indicate that the user prefers Toyota® automobiles. For example, the user may have previously indicated ownership of a Toyota® automobile in a user profile or social media entry, visited a Toyota® automobile website, more closely fits a Toyota demographic profile as compared with a Cadillac® demographic profile, or the like. Given the user affinity for Toyota® automobiles as determined by the audio stream manipulation module, the advertisement featuring a Cadillac® automobile in the audio stream is replaced with an advertisement featuring a Toyota® automobile. The Toyota® automobile ad can be obtained from an ad server 124 in a conventional manner. As described in more detail herein, the ad segment in the audio stream containing the Cadillac® automobile ad is replaced in real time with an ad segment containing the Toyota® ad to produce a modified audio stream that contains audible advertising customized for the particular user. If necessary, the duration of the ad segment and/or the audio stream can be adjusted to allow the substitute ad segment to fit into the time slot provided by the ad segment being replaced. For example, the timing of the substitute ad segment and/or the audio stream can be elongated or shortened, sped up or slowed down to allow the substitute ad segment to fit into the time slot. 3) An identified functional segment in the audio stream can be replaced with a different functional segment served from a repository of substitute functional segments associated with the audio stream manipulation module. In an off-line process, a particular user can configure or customize functional segments for a particular audio stream. For example, a navigation device might generate a navigation instruction as an audio stream in the form, “take the exit toward Interstate 405 in 500 feet” A functional segment of this example audio stream might correspond to the keyword phrase, “Interstate 405.” The off-line process allows the user to generate a substitution keyword phrase to replace a given keyword phrase. For example, the substitution keyword phrase, “the 405” might be generated by the user in the off-line process to replace the given keyword phrase, “Interstate 405.” In this example, the substitution keyword phrase, “the 405” and the corresponding given keyword phrase, “Interstate 405” can be associated and stored in the repository of substitute functional segments. The audio stream manipulation module has access to the repository of substitute functional segments. In real-time, the audio stream manipulation module can scan the received audio stream for the presence of any of the given functional segments stored in the repository of substitute functional segments. Any functional segments of the received audio stream matching a given functional segment stored in the repository of substitute functional segments can be replaced with the associated substitute functional segment in the audio stream. As a result, the audio stream is modified to include the substitute functional segment. In the example set forth above, the resulting modified audio stream would be output to a user in real time as, “take the exit toward the 405 in 500 feet.” One or more of these relevant, user-configured functional segments can be substituted into the audio stream in real time to produce a modified audio stream that contains functional segments customized fur the particular user. It will be apparent to those of ordinary skill in the art in view of the disclosure herein that a variety of other embodiments and applications of the techniques described herein can be similarly implemented.

Referring now to FIG. 1, a block diagram illustrates an example ecosystem 101 in which an in-vehicle infotainment (IVI) system 150 and an audio stream manipulation module 200 of an example embodiment can be implemented. These components are described in more detail below. Ecosystem 101 includes a variety of systems and components that can generate and/or deliver one or more audio streams to the IVI system 150 and/or the audio stream manipulation module 200. For example, a standard over-the-air radio broadcast network 112 can transmit AM, FM, or UHF radio signals in which content, such as music, speech, news programming, or other programming content can be encoded. Advertising segments can also be embedded into the audio program content transmitted by the radio broadcast networks 112 as audio streams. Antenna(s) 114 in a vehicle 119 can receive these over-the-air audio streams and deliver the audio streams to an in-vehicle radio receiver 116 and/or the IVI system 150 for selection by and rendering to a user/listener in the vehicle 119. Vehicle 119 can also include navigation or GPS devices 117 or other in-vehicle devices 118 that can generate programming content or functional audio streams. These devices (117 and 118) can also provide audio streams to the IVI system 150 and/or the audio stream manipulation module 200 as shown in FIG. 1.

Similarly, ecosystem 101 can include a wide area data/content network 120. The network 120 represents a conventional wide area data/content network, such as a cellular telephone network, satellite network, pager network, or other wireless broadcast network, gaming network. WiFi network, peer-to-peer network, Voice Over IP (VoIP) network, etc., that can connect a user or client system with network resources 122, such as websites, servers, call distribution sites, head/end sites, or the like. The network resources 122 can generate and/or distribute audio streams, which can be received in vehicle 119 via one or more antennas 114. Antennas 114 can serve to connect the IVI system 150 and/or the audio stream manipulation module 200 with as data or content network 120 via cellular, satellite, radio, or other conventional signal reception mechanism. Such cellular data or content networks are currently available (e.g., Verizon™, AT&T™, T-Mobile™, etc.). Such satellite-based data or content networks are also currently available (e.g., SiriusXM™, HughesNet™, etc.). The conventional broadcast networks, such as AM/FM radio networks, pager networks, UHF networks, gaming networks, WiFi networks, peer-to-peer networks, Voice Over IP (VoIP) networks, and the like are also well-known. Thus, as described in more detail below, the IVI system 150 can include a radio receiver, a cellular receiver, and/or a satellite-based data or content modem to decode data and/or content signals as audio streams received via radio signals, cellular signals, and/or satellite. As a result, the IVI system 150 and/or the audio stream manipulation module 200 can obtain a data/content connection with network resources 122 via network 120 to receive audio streams and other data via the network cloud 120.

As shown in FIG. 1, the IVI system 150 and/or the audio stream manipulation module 200 can also receive audio streams from user mobile devices 130. The user mobile devices 130 can represent standard mobile devices, such as cellular phones, smartphones, personal digital assistants (PDA's), MP3 players, tablet computing devices (e.g., iPad), laptop computers, CD players, and other mobile devices, which can produce or deliver audio streams to the IVI system 150 and/or the audio stream manipulation module 200. As shown in FIG. 1, the mobile devices 130 can also be in data communication with the network cloud 120. The mobile devices 130 can source audio stream content from internal memory components of the mobile devices 130 themselves or from network resources 122 via network 120. In either case, the IVI system 150 and/or the audio stream manipulation module 200 can receive these audio streams from the user mobile devices 130 as shown in FIG. 1.

In various embodiments, the mobile device 130 interface and user interface between the IVI system 150 and the mobile devices 130 can be implemented in a variety of ways. For example, in one embodiment, the mobile device 130 interface and user interface between the IVI system 150 and the mobile devices 130 can be implemented using, a USB interface and associated connector.

In another embodiment, the mobile, device 130 interface and user interface between the IVI system 150 and the mobile devices 130 can be implemented using as wireless protocol, such as WiFi or Bluetooth (BT). WiFi is a popular wireless technology allowing an electronic device to exchange data wirelessly over a computer network. Bluetooth is a wireless technology standard for exchanging data over short distances.

In the example embodiment shown in FIG. 1, the IVI system 150 represents various types of standard multimedia entertainment systems that may include sound systems, satellite radio receivers, AM/FM broadcast radio receivers, compact disk (CD) players, MP3 players, video players, smartphone interfaces, wireless computing interfaces, navigation/GPS system interfaces, and the like. As shown in FIG. 1, such IVI systems 150 can include tuner or modem module 152 and/or players 154 for selecting and rendering audio content received in audio streams from the audio stream sources 110 described above. The IVI system 150 can also include a display 156 to enable a user to view information and control settings provided, by the IVI system 150. Speakers 158 or audio output jacks are provided on standard IVI systems 150 to enable a user to hear the audio streams.

The IVI system 150 of an example embodiment can also be configured with various notification interfaces 162-168. As described in more detail below, the IVI system 150 and the audio stream manipulation module 200 can detect call-to-action elements embedded in a particular audio stream. In response to a detection of a call-to-action element, the notification interfaces 162-168 can be used to notify a user and/or a third party of a call-to-action event via various modes of communication including a notification by a phone interface 162, an email interface 164, a network or web interface 155, or other notification interface 168. The IVI system 150 and/or the audio stream manipulation module 200 can also provide or share a database 170 for the storage of various types of information as described in more detail below.

In a particular embodiment, the IVI system 150 and the audio stream manipulation module 200 can be implemented as in-vehicle components of vehicle 119. In various example embodiments, the IVI system 150 and the audio stream manipulation module 200 can be implemented as integrated components or as separate components. In an example embodiment, the software components of the IVI system 150 and/or the audio stream manipulation module 200 can be dynamically upgraded, modified, and/or augmented by use of the data connection with the mobile devices 130 and/or the network resources 122 via network 120. The IVI system 150 can periodically query a mobile device 130 or a network resource 122 for updates or updates can be pushed to the IVI system 150.

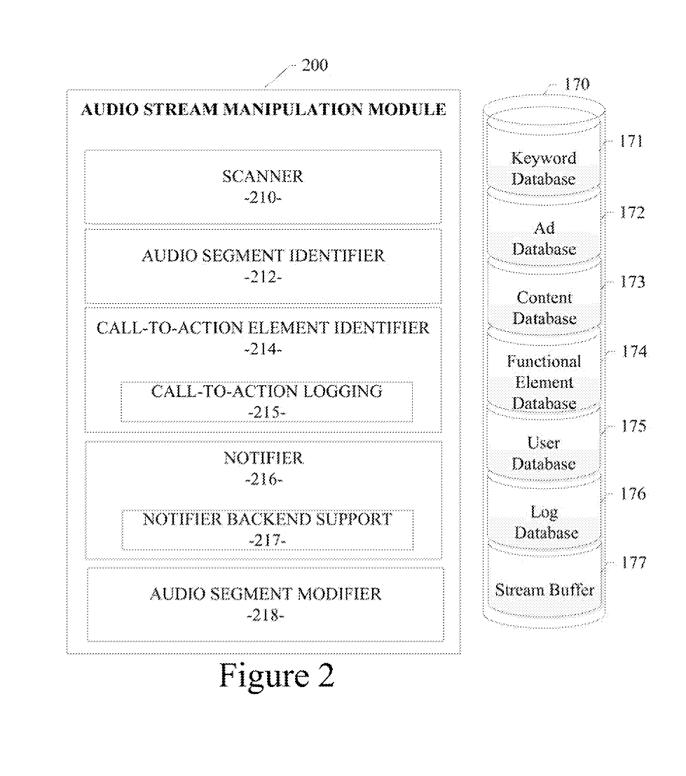

FIG. 2 illustrates the components of the audio stream manipulation module 200 of an example embodiment. In the example embodiment, the audio stream manipulation module 200 can be configured to include an interface with the IVI system 150 or other in-vehicle subsystem through which the audio stream manipulation module 200 can receive audio streams from the various audio stream sources 110 described above. In another embodiment, the audio stream manipulation module 200 can be configured to receive the audio streams directly from the various audio stream sources 110. In an example embodiment, the audio stream manipulation module 200 can be configured to include a scanner module 210, an audio segment identifier module 212, a call-to-action element identifier module 214, a notifier module 216, and an audio segment modifier module 218. Each of these modules can be implemented as software or firmware components executing within an executable environment of the audio stream manipulation module 200 operating within or in data communication with the IVI system 150. Alternatively, these modules can be implemented as executable components operating within an executable environment of the network cloud 120 operating in data communication with the audio stream manipulation module 200 and IVI system 150. Each of these modules of an example embodiment is described in more detail below in connection with the figures provided herein.

The scanner module 210 of an example embodiment is responsible for performing speech or text recognition on a received audio stream using standard speech recognition technology. As described above, the audio stream manipulation module 200 can receive a plurality of audio streams from a variety of sources 110 shown in FIG. 1 and described above. Each of the audio streams can be tagged with an identification of the source of the audio stream and a description of the path taken from the source to the audio stream manipulation module 200. The audio streams can be received at the IVI system 150 and passed to the audio stream manipulation module 200 or the audio streams can be received directly at the audio stream manipulation module 200. The text/speech analysis performed on the received audio stream by the audio stream manipulation module 200 can produce as text string corresponding to the conversion of the audio stream from an audible form to a text form. Techniques for performing this text conversion are well-known in the art. The text string can be parsed to isolate or extract keywords and keyword phrases present in the audio stream. These keywords and keyword phrases can be stored in a keyword database 171 of database 170 along with an identification of the corresponding audio stream. Once the scanner module 210 has processed the received audio stream to extract keywords and keyword phrases from the audio stream, the audio segment identifier module 212 can be activated to further process the audio stream keywords and keyword phrases.

The audio segment identifier module 212 of an example embodiment is responsible for identifying particular types of audio segments in the received audio stream. The audio segment identifier module 212 can use the keywords and keyword phrases extracted from the audio stream by the scanner module 210. In an example embodiment, the types of audio segments can include content segments, advertising (ad) segments, and functional content segments or functional segments. The keywords and keyword phrases found in the audio stream can be compared with a library of keywords and keyword phrases (e.g., included as part of keyword database 171) known to be included in or indicative of particular types of audio segments. The keyword/keyword phrase library can be built up over time in audio stream manipulation module 200 and/or downloaded from to network resource 122 via network 120. The comparison of extracted audio stream keywords/keyword phrases with keyword/keyword phrases from the library can result in a correlation between the audio stream words and words known to be associated with content segments, ad segments, or functional segments. For example, such keywords and keyword phrases might include the names of merchants or products, phone numbers, websites, links, hashtags, or email addresses, and the like associated with radio advertising. The radio advertising related keywords and keyword phrases can be used to identify ad segments in the audio stream, in another example, the audio stream keywords/keyword phrases might correlate to words, phrases, or word patterns typically used in functional segments, such as navigation instructions or audible user instructions. For example, such keywords and keyword phrases might correspond to portions of an audio instruction from a navigation device (e.g., “turn left at Maple Street in 500 feet). The functionally related keywords and keyword phrases can be used to identify functional segments in the audio stream. In yet another example, the audio stream keywords/keyword phrases might not correlate to ad segments or functional segments, or the keywords/keyword phrases might correlate to words, phrases, or word patterns typically used in content segments, such as music, songs, news programming, radio programming, talk radio, or the like. The content related keywords and keyword phrases can be used to identify content segments in the audio stream. Audio segments in the audio stream can also be identified and/or classified using other hints, such as changes in pitch or volume, gaps in the broadcast, the timing of the broadcast, knowledge of the patterns of particular broadcasters, detection of musical beats, cadence of speech, or other acoustic hints (generally denoted herein as the acoustic properties). Using combinations of the identified keywords/keyword phrases, the acoustic properties, and other related information, audio segments can be identified in real-time. The timing associated with the identified audio segments (e.g., the start time, end time, duration, etc.) can also be recorded. This information can be retained in database 170.

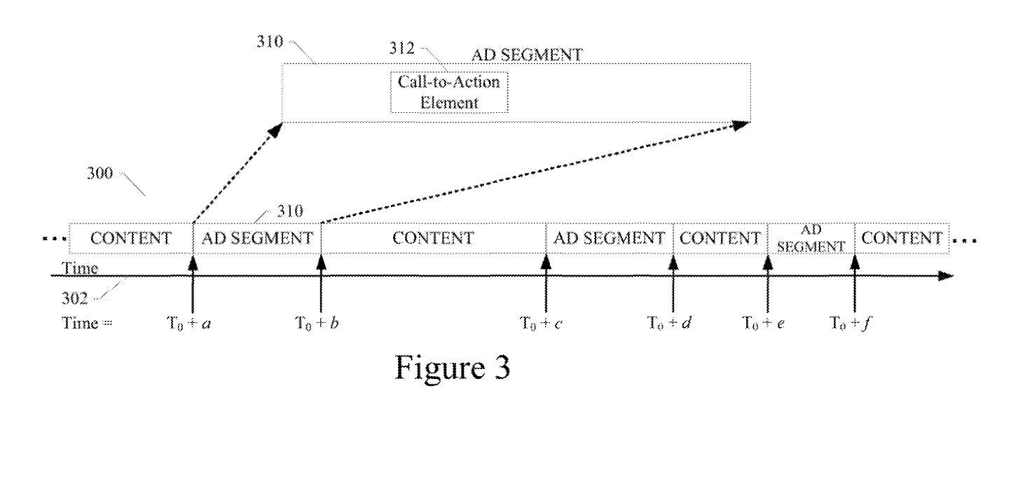

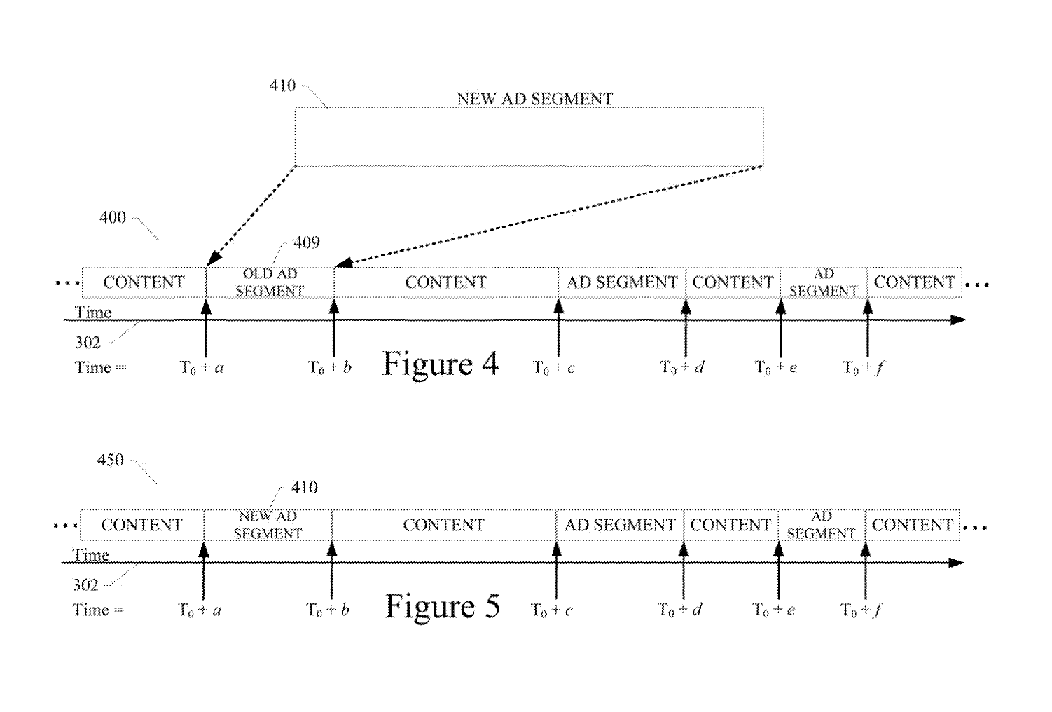

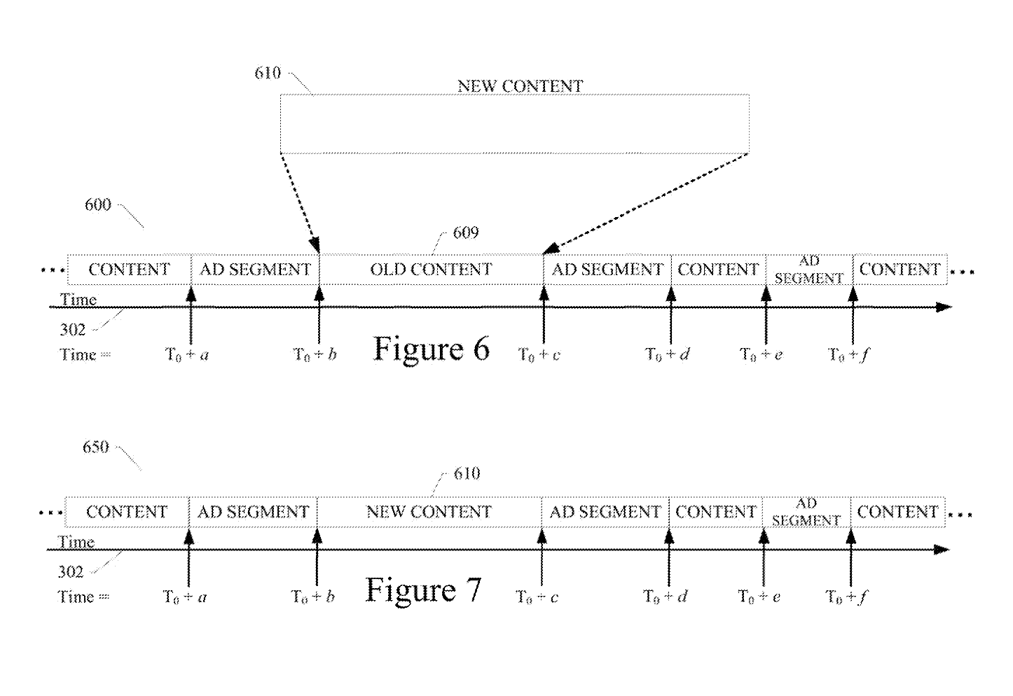

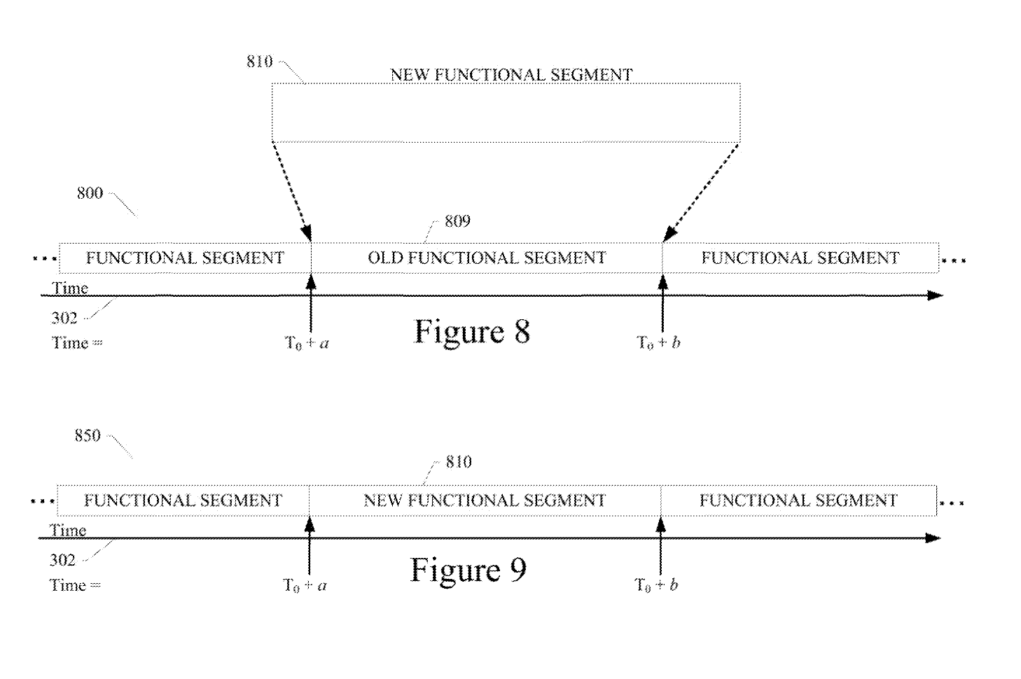

Referring now to FIG. 3, an example audio stream 300 is shown as a connected set of audio segments including content segments and ad segments. The component segments of the audio stream 300 are temporally related and occupy a particular position in the audio stream 300 based on a location on timeline 302. As such, each segment has a unique starting and ending time on the timeline 302. As described above, particular audio segments of the audio stream 300, such as ad segment 310, can be identified. In other examples, a sample audio stream 400 is shown in FIG. 4 and a sample audio stream 600 is shown in FIG. 6. A sample audio stream 800 with functional segments is shown in FIG. 8. Information defining the audio segment composition of a particular audio stream can be retained in database 170.

Referring again to FIGS. 2 and 3, the call-to-action element identifier module 214 of an example embodiment is responsible for analyzing the content of identified audio stream segments to determine if there are any call-to-action elements in the audio segments identified as ad segments. Call-to-action elements correspond to keywords or keyword phrases that prompt a listener to take some action, such as call a phone number, visit a website, send a text message, or the like. FIG. 3 illustrates the composition of an example audio stream 300 and the identification of call-to-action element 312 performed by the call-to-action element identifier module 214 of audio stream manipulation module 200. As shown in FIG. 3, these call-to-action elements 312 can be embedded in an ad segment 310 by an advertiser. The call-to-action content 312 can be identified by comparing the keywords or keyword phrases in the ad segment 310 with reference keywords or keyword phrases known to be associated with call-to-action elements. As a result of this analysis of the ad segments of a particular audio stream, the call-to-action element identifier module 214 of an example embodiment can identify and isolate these call-to-action elements. The call-to-action element identifier module 214 can further determine a type of action being prompted by the ad segment. For example, the call-to-action element identifier module 214 can determine that a particular call-to-action element corresponds to a phone number. Thus, the call-to-action element identifier module 214 can tag the call-to-action element as related to a phone interface. Similarly, the call-to-action element identifier module 214 can tag a call-to-action element that includes a Uniform Resource Locator (URL) or web address as related to a web interface. The call-to-action element identifier module 214 can also tag a call-to-action element that includes an email address as related to an email interface. In this manner, the call-to-action element identifier module 214 can tag a call-to-action element as related to a particular form of communication or action medium. When a call-to-action element in an ad segment is identified and a related communication medium is defined, the call-to-action element identifier module 214 can activate the notifier module 216 to invite, prompt, or assist the user to respond to the call to action in a variety of ways. Additionally, as shown in FIG. 2, the call-to-action element identifier module 214 of an example embodiment can include a call-to-action logging module 215. The call-to-action logging module 215 can be configured to log the user actions taken in response to the calls-to-action in the audio stream to record the effectiveness of the calls-to-action. As a result, the call-to-action logging modulo 215 provides information that can be used to associate particular user actions with associated calls to action. In a broader sense, the call-to-action logging module 215 provides information that can be used to associate particular user actions with any ad segment identified in the audio stream. As a result, the call-to-action logging module 215 is an effective tool for tracking the effectiveness of particular ad segments included in an audio stream. In an example embodiment, the call-to-action logging module 215 can be configured to collect data indicative of the efficacy of particular ads in an audio stream in a manner similar to the way that traditional online advertisers track click through rates (CTRs). In this manner, the effectiveness and thus the value of particular ads in an audio stream can be quantified.

Referring still to FIGS. 2 and 3, the notifier module 216 of an example embodiment is responsible for inviting, prompting, or assisting the user to respond to a call to action in a variety of ways. Once the call-to-action element identifier module 214 processes a call-to-action element in an ad segment and defines a related communication medium, the notifier module 216 can assist the user to perform the action. For example, the notifier module 216 can cause system elements to automatically dial a phone number extracted from the ad segment 310 and/or the related call-to-action element 312. In a particular example embodiment, the notifier module 216 of audio stream manipulation module 200 can use the notification interfaces 162-168 (see FIG. 1 of IVI system 150 to effect these actions. In another example, the notifier module 216 can cause system elements to automatically send an email to an email address extracted from the ad segment 310 and/or the related call-to-action element 312. Similarly, notifier module 216 of audio stream manipulation module 200 can automatically bookmark or pin a webpage link extracted front the call-to-action element 312, automatically send a text message to a phone number extracted from the call-to-action element 312, automatically send a tweet, or otherwise automatically communicate with a third party or external system in response to the call-to-action element 312 from the ad segment 310 identified in the audio stream 300. The notifier module 216 of an example embodiment can also be configured to send an email or a text to the user's own account (e.g., to self) as a reminder note. Moreover, the notifier module 216 can be configured to “pin” a notification or cause the notification to be sent or shown later as described in more detail below. The notifier module 216 of an example embodiment can also include a notifier backend support clement 217 to assist the notifier module 216 in establishing a connection between the user system and the third party system (e.g., the vendor system). Because the call-to-action element in the ad segment identified in the audio stream can be detected in real time, the timing of the call-to-action in the audio stream can be synchronized with the prompted user action associated with the call-to-action. Additionally, the notifier module 216 can be configured to serially or in parallel perform a plurality of actions in response to a single call-to-action element 312. Moreover, the actions performed by the notifier module 216 can be configured to be conditional upon the status of another defined action or object. For example, the notification action performed by the notifier module 216 can be delayed until a user is online, delayed until as user vehicle arrives at a destination, delayed until a user's mobile device is connected to the network, or other defined action or object status condition is satisfied. The notifier module 216 of audio stream manipulation module 200 can also log the user actions taken in response to the calls-to-action in the audio stream to record the effectiveness of the calls-to-action. These log entries can be retained in the log database 176 shown in FIG. 2. In this manner, a driver of vehicle 119 can be assisted by the IVI system 150 and the and stream manipulation module 200 when calls-to-action are received in an audio stream.

Referring now to FIGS. 2 and 4 through 9, the audio segment modifier module 218 of an example embodiment is responsible for performing various editing operations on an audio stream in real time. In one embodiment, the audio segment modifier module 218 can be configured to substitute a new audio segment, for an old audio segment present in a received audio stream. As described above, the audio segment identifier module 212 identifies audio segments in a received audio stream and identifies particular types of audio segments in the received audio stream. As a result, the audio segment modifier module 218 can determine the presence, type, and location of particular audio segments in an audio stream. Once the location of a particular audio segment is known (as determined by time markers on timeline 302), the audio segment modifier module 218 can replace the audio segment with a different audio segment, which is inserted into the location in the audio stream formerly occupied by the replaced audio segment. If necessary, the duration of the substitute audio segment and/or the audio stream can be adjusted to allow the substitute audio segment to fit into the time slot provided by the audio segment being replaced. For example, the timing of the substitute audio segment and/or the audio stream can be elongated or shortened, sped up or slowed down to allow the substitute audio segment to fit into the available time slot. FIGS. 4 through 9 illustrate various forms of these modification operations in various example embodiments.

FIGS. 4 and 5 illustrate the composition of an example audio stream 400/450 and the substitution of an old ad segment 409 with a new ad segment 410 as performed by the audio segment modifier module 218 of an example embodiment. As shown in FIG. 4, the audio stream 400 has been processed by the audio segment identifier module 212 to identify and classify the audio segments in a received audio stream. Given this information, the audio segment modifier module 218 can locate old ad segment 409 based on its time markers on timeline 302. As described in more detail below, a new ad segment 410 can be selected from an ad repository and substituted into the audio stream 400 at the location of old ad segment 409. The resulting modified audio stream is shown in FIG. 5, where modified audit stream 450 now includes the new ad segment 410. In some cases, it may be necessary to buffer the ad stream 400 to enable the new ad segment 410 to be inserted into the audio stream 400 without gaps or overwrites. A stream buffer 177 (shown in FIG. 2) is provided for this purpose. The resulting modified audio stream 450 can be played or rendered with the new ad segment 410 being seamlessly included in the audio stream 450. It will be apparent to those of ordinary skill in the art in view of the disclosure herein that any ad segment in a received audio stream can be modified using the techniques described herein.

Given the system and method to modify any ad segment in a received audio stream as described above, an example embodiment also includes systems and methods to target ads in ad segments of an audio stream for a particular individual. As shown in FIG. 2, the database 170 can include an ad database 172 in which a variety of ad creatives can be stored. An ad creative is an ad template that can be customized for a particular individual. The ad creatives in ad database 172 can be downloaded from network resources 122, ad server 124, or mobile devices 130.

Additionally, user information can be obtained from or about the users of the IVI system 150 and audio stream manipulation module 200 of an example embodiment. For example, user profiles or user preference parameters are often maintained for system users. This user profile information can be explicitly prompted and entered by particular users. The explicit user information can include various types of demographic information and specified user preferences. Additionally, user behavioral information can be implicitly obtained by monitoring user inputs, tracking the functionality most often used, monitoring the information most often requested by the user, and the like. User profile and behavioral information can be obtained from user data sources 126 via network 120 in conventional ways. This explicit and implicit user information can be used to infer user affinity for particular individual users. Additionally, the particular user's current context (e.g., location, destination, time, etc.) can also be used to further qualify user affinity. This user affinity information can be obtained by the audio segment modifier module 218 and retained in user database 175 shown in FIG. 2.

Given the ad creatives in ad database 172 and the user affinity information in user database 175, the audio segment modifier module 218 can search the ad creatives in ad database 172 to locate an ad creative that is most closely aligned with or targeted for the affinity preferences of a particular user. This targeted ad creative can be retrieved from the ad database 172 and further customized for the particular user. For example, elements of the ad (e.g., language spoken, images presented, geographic locations identified, options offered, etc.) can be modified to be consistent with the user affinity for the particular user as defined in the user database 175. This customized ad can be further processed to fit within the space or time constraints of a location in an audio stream in which the customized ad is inserted by the audio segment modifier module 218 as described above. In this manner, the audio segment modifier module 218 can select a targeted and customized ad for a particular user and insert the ad into an audio stream in real time. As a result, the audio stream is highly tailored for as very specific audience and this becomes a much more effective advertising tool.

FIGS. 6 and 7 illustrate the composition of an example audio stream and the substitution of content segments performed by the audio segment modifier module 218 of an example embodiment. As described above, the audio stream 600 shown in FIG. 6 can be processed by the audio segment identifier module 212 to identify and classify the audio segments in the received audio stream. Given this information, the audio segment modifier module 218 can locate old content segment 609 based on its time markers on timeline 302. As described in more detail below, as new content segment 610 can be selected from content repository and substituted into the audio stream 600 at the location of old content segment 609. For example, a national weather report in an audio stream can be replaced with a local weather report associated with a particular geographical location of more interest to a particular listener. The resulting modified audio stream is shown in FIG. 7, where modified audio stream 650 now includes the new content segment 610. In some cases, it may be necessary to buffer the ad stream 600 to enable the new content segment 610 to be inserted into the audio stream 600 without gaps or overwrites. A stream buffer 177 (shown in FIG. 2) is provided for this purpose. The resulting modified audio stream 650 can be played or rendered with the new content segment 610 being seamlessly included in the audio stream 650. As described above, the timing of the modified audio stream 650 can be adjusted to allow the substitute content segment to fit into the available time slot. It will be apparent to those of ordinary skill in the art in view of the disclosure herein that any content segment in a received audio stream can be modified using the techniques described herein.

As described above with respect to targeted ads, the new content segment 610 can also be targeted based on the user affinity information in user database 175. A content database 173 can be used to retain various content segments that can be customized for particular users. These customizable content segments can be downloaded from network resources 122 or mobile devices 130 and stored in content database 173. Given the customizable content segments in content database 173 and the user affinity information in user database 175, the audio segment modifier module 218 can search the content database 173 to locate a customizable content segment that is most closely aligned with or targeted for the affinity preferences of a particular user. This customizable content segment can be retrieved from the content database 173 and further customized for the particular user. Then, the customized content segment can be inserted into the audio stream 600 to produce the modified audio stream 650 as shown in FIG. 7 and described above.

Additionally, an example embodiment can provide connected content items, for example, connected news stories. The connected content item functionality of an example embodiment can be used to link related content items in one of several ways, including: 1) linking two or more content segments in one or more audio streams, 2) linking a visually displayed content item with a corresponding content segment of an audio stream related to the visually displayed content item, and 3) linking two or more related visually displayed content items. In this embodiment, for example, as user can be shown as snippet of a news item (or an audio clip of the news snippet can be played for the user) on the in-vehicle infotainment (IVI) system 150 of vehicle 119 as she enters the vehicle 119. Then, the IVI 150 can follow up by showing the user a longer form of the same or related topic (or playing, a longer audio clip of the same or related topic). An example of this can include as tweet version from CNN® of breaking news on “Conflict in Syria,” which can be scanned and matched with keywords to a fifteen minute related news story from local radio station, followed by related archival material on the Syrian conflict, from NPR® or other news/content source. The matching of content items (either visual or audio) can be based on speech to text conversion of audio stream and based on keywords found in the content that the user just listened to or viewed and the archive of content from different media stories. This functional capability makes the IVI 150 a connecting element for the audio-web (HTML, like).

FIGS. 8 and 9 illustrate the composition of an example audio stream and the substitution of functional segments performed by the audio segment modifier module 218 of an example embodiment. As described above, the audio stream 800 shown in FIG. 8 can be processed by the audio segment identifier module 212 to identify and classify the audio segments in the received audio stream. Given this information, the audio segment modifier module 218 can locate old functional segment 809 based on its time markers on timeline 302. As described in more detail below, a new functional segment 810 can be selected from a functional element data repository 174 and substituted into the audio stream 800 at the location of old functional segment 809. For example, a navigation instruction to a driver in an audio stream that contains an old functional segment, “take the exit toward Interstate 405 in 500 feet” can be replaced with a new functional segment. “take the exit toward the 405 in 500 feet.” The resulting modified audio stream is shown in FIG. 9, where modified audio stream 850 now includes the new functional segment 810. In some cases, it may be necessary to buffer the ad stream 800 to enable the new functional segment 810 to be inserted into the audio stream 800 without gaps or overwrites. A stream buffer 177 (shown in FIG. 2) is provided for this purpose. The resulting modified audio stream 850 can be played or rendered with the new functional segment 810 being seamlessly included in the audio stream 850. It will be apparent to those of ordinary skill in the art in view of the disclosure herein that any functional segment in a received audio stream can be modified using the techniques described herein.

The new functional segment 810 can be generated or configured using an off-line process (e.g., a process that does not need to occur in real time) that allows the user to generate a substitution keyword phrase to replace a given keyword phrase. A functional element database 174 can be used to retain functional segments that have been customized by or for particular users. In some cases, customized functional segments can be downloaded from network resources 122 or mobile devices 130 and stored in functional element database 174. Given the set of customized functional segments in functional element database 174, the audio segment modifier module 218 can search the functional element database 174 to locate a customized functional segment that is associated with the old functional segment being replaced. This associated customized functional segment can be retrieved from the functional element database 174 and further customized for the particular user, if necessary. Then, the new customized functional segment can be inserted into the audio stream 800 to produce the modified audio stream 850 as shown in FIG. 9 and described above.

As used herein and unless specified otherwise, the term “mobile device” includes any computing or communications device that can communicate with the IVI system 150 and/or the audio stream manipulation module 200 described herein to obtain read or write access to data signals, messages, or content communicated via any mode of data communications. In many cases, the mobile device 130 is a handheld, portable device, such as a smart phone, mobile phone, cellular telephone, tablet computer, laptop computer, display pager, radio frequency (RF) device, infrared (IR) device, global positioning device (GPS), Personal Digital Assistants (PDA), handheld computers, wearable computer, portable game console, other mobile communication and/or computing device, or an integrated device combining one or more of the preceding devices, and the like. Additionally, the mobile device 130 can be a computing device, personal computer (PC), multiprocessor system, microprocessor-based or programmable consumer electronic device, network PC, diagnostics equipment, a system operated by a vehicle 119 manufacturer or service technician, and the like, and is not limited to portable devices. The mobile device 130 can receive and process data in any of a variety of data formats. The data format may include or be configured to operate with any programming format, protocol, or language including, but not limited to, JavaScript, C++, iOS, Android, etc.

As used herein and unless specified otherwise, the term “network resource” includes any device, system, or service that can communicate with the IVI system 150 and/or the audio stream manipulation module 200 described herein to obtain read or write access to data signals, messages, or content communicated via any mode of inter-process or networked data communications. In many cases, the network resource 122 is a data network accessible computing platform, including client or server computers, websites, mobile devices, peer-to-peer (P2P) network nodes, and the like. Additionally, the network resource 122 can be a web appliance, a network router, switch, bridge, gateway, diagnostics equipment, a system operated by a vehicle 119 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The network resources 122 may include any of a variety a providers or processors of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3-MP3, and the like), video (e.g., MP4, and the like), and any proprietary interchange format defined by specific content sites can be supported by the various embodiments described herein.

The wide area data network 120 (also denoted the network cloud) used with the network resources 122 can be configured to couple one computing or communication device with another computing or communication device. The network may be enabled to employ any form of computer readable data or media for communicating information from one electronic device to another. The network 120 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. The network 120 can include the Internet in addition to other wide area networks (WANs), cellular telephone networks, satellite networks, over-the-air broadcast networks, AM/FM radio networks, pager networks, UHF networks, other broadcast networks, gaming networks, WiFi networks, peer-to-peer networks, Voice Over IP (VoIP) networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected, set of networks, including those based on differing architectures and protocols, a router or gateway can act as a link between networks, enabling messages to be sent between computing devices on different networks. Also, communication links within networks can typically include twisted wire pair cabling, USB, Firewire, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

The network 120 may further include any of a variety of wireless sub-networks that may further overlay stand-alone ad-hoe networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly.

The network 120 may further employ a plurality of access technologies including 2nd (2G), 2.5, 3rd (3G), 4th (4G) generation radio access fur cellular systems, WLAN, Wireless Router (WR) mesh, and the like. Access technologies such as 2G, 3G, 4G, and future access networks may enable wide area coverage fur mobile devices, such as one or more of client devices, with various degrees of mobility. For example, the network may enable a radio connection through a radio network access, such as Global System for Mobile communication (GSM), General Packet Radio Services (GPRS), Enhanced Data GSM Environment (EDGE), Wideband Code Division Multiple Access (WCDMA), CDMA2000, and the like. The network may also be constructed for use with various other wired and wireless communication protocols including TCP/IP, UDP, SIP, SMS, RTP, WAP, CDMA, TDMA, EDGE, UMTS, GPRS, GSM, UWB, WiMax, IEEE 802.11x, and the like. In essence, the network 120 may include virtually any wired and/or wireless communication mechanism by which information may travel between one computing device and another computing device, network, and the like.

In a particular embodiment, a mobile device 130 and/or a network resource 122 may act as a client device enabling a user to access and use the IVI system 150 and/or the audio stream manipulation module 200 to interact with one or more components of as vehicle subsystem. These client devices 130 or 122 may include virtually any computing device that is configured to send and receive information over a network, such as network 120 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, game consoles, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHML), and the like, to display and send a message with relevant information.

The client devices may also include at least one client application that is configured to receive content or messages from another computing, device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

The IVI system 150 and/or the audio stream manipulation module 200 can be implemented using systems that enhance the security of the execution environment, thereby improving security and reducing the possibility that the IVI system 150 and/or the audio stream manipulation module 200 and the related services could be compromised by viruses or malware. For example, the IVI system 150 and/or the audio stream manipulation module 200 can be implemented using a Trusted Execution Environment, which can ensure that sensitive data is stored, processed, and communicated in a secure way.

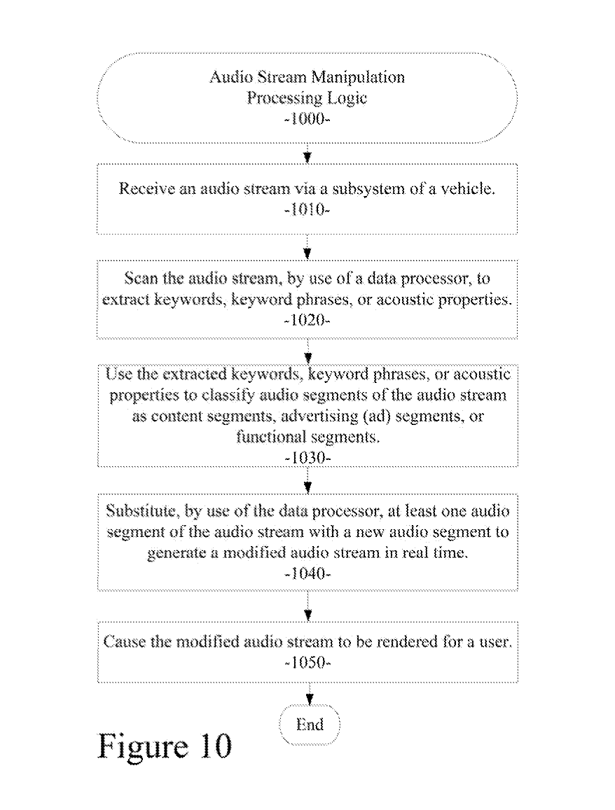

FIG. 10 is a processing flow diagram illustrating an example embodiment of the systems and methods pertaining to an audio stream manipulation system for manipulating an audio stream for an in-vehicle infotainment system as described herein. The method 1000 of an example embodiment includes: receiving an audio stream via a subsystem of a vehicle (processing block 1010); scanning the audio stream, by use of a data processor, to extract keywords, keyword phrases, or acoustic properties (processing block 1020); using the extracted keywords, keyword phrases, or acoustic properties to classify audio segments of the audio stream as content segments, advertising (ad) segments, or functional segments (processing block 1030); substituting, by use of the data processor, at least one audio segment of the audio stream with a new audio segment to generate a modified audio stream in real time (processing block 1040); and causing the modified audio stream to be rendered for a user (processing block 1050).

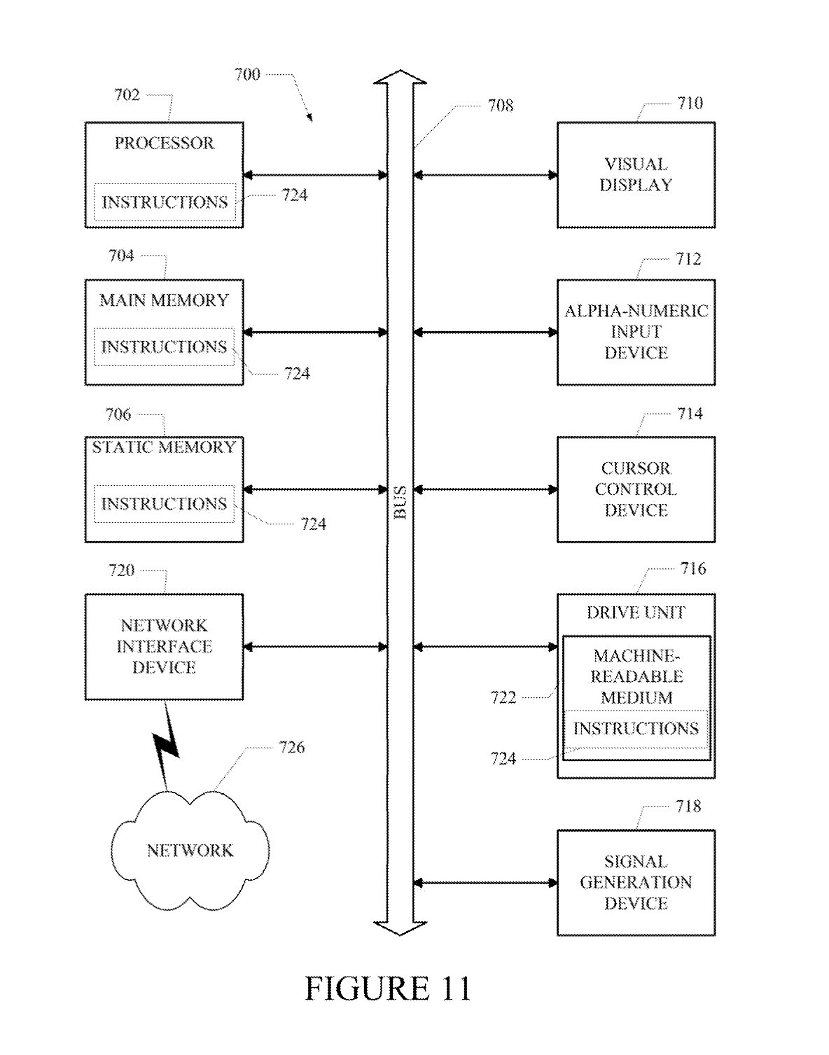

FIG. 11 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute as set for multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via as bus 708. The computer system 700 may further include a visual display unit 710 (e.g., as liquid crystal display (LCD) or other visual display terminology). The computer system 700 also includes an input device 712 (e.g., a keyboard), as cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over as network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying as set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of as single disclosed embodiment. Thus, the following claims are hereby incorporated into the Detailed Description, with each claim standing on its own as a separate embodiment.

What is claimed is:

1. A method comprising:
receiving an audio stream via a subsystem of a vehicle;
scanning the audio stream, by use of a data processor, to extract keywords, keyword phrases, or acoustic properties;
using the extracted keywords, keyword phrases, or acoustic properties to classify audio segments of the audio stream as content segments, advertising (ad) segments, or functional segments;
substituting, by use of the data processor, at least one audio segment of the audio stream with a new audio segment to generate a modified audio stream in real time; and
causing, the modified audio stream to be rendered for a user.

2. The method as claimed in claim 1 wherein, the scanning includes at least one operation from the group consisting of 1) comparing keywords and keyword phrases found in the audio stream with a library of keywords and keyword phrases known to be included in or indicative of particular types of audio segments, and 2) extracting elements of acoustic properties from the audio stream.

3. The method as claimed in claim 1 including identifying at least one ad segment in the audio stream and determining if the ad segment includes a call-to-action element.

4. The method as claimed in claim 3 including causing a notification interlace to prompt the user to take action if the ad segment includes a call-to-action element.

5. The method as claimed in claim 1 including identifying at least one ad segment in the audio stream and substituting the at least one ad segment in the audio stream with a new ad segment retrieved from a database.

6. The method as claimed in claim 5 wherein the new ad segment is customized for a particular user by use of user affinity information.

7. The method as claimed in claim 6 wherein the user affinity information includes explicit and implicit user information.

8. The method as claimed in claim 1 including substituting at least one content segment of the audio stream with a new content segment retrieved from a database.

9. The method as claimed in claim 1 including substituting at least one functional segment of the audio stream with a new functional segment.

10. The method as claimed in claim 1 wherein at least a portion of the classifying of the audio segments of the audio stream being performed in a network cloud.

11. A system comprising:
a data processor;
a vehicle subsystem interface to receive an audio stream via a subsystem of a vehicle; and
an audio stream manipulation module being configured to:
scan the audio stream, by use of the data processor, to extract keywords, keyword phrases, or acoustic properties;
use the extracted keywords, keyword phrases, or acoustic properties to classify audio segments of the audio stream as content segments, advertising (ad) segments, or functional segments;
substitute, by use of the data processor, at least one audio segment of the audio stream with a new audio segment to generate a modified audio stream in real time; and
cause the modified audio stream to be rendered for a user.

12. The system as claimed in claim 11 being thriller configured to perform at least one operation from the group consisting of: 1) compare keywords and keyword phrases found in the audio stream with a library of keywords and keyword phrases known to be included in or indicative of particular types of audio segments, and 2) extract elements of acoustic properties from the audio stream.

13. The system as claimed in claim 11 being further configured to identify at least one ad segment in the audio stream and determine if the ad segment includes a call-to-action element.

14. The system as claimed in claim 13 being further configured to cause a notification interface to prompt the user to take action if the ad segment includes a call-to-action element.

15. The system as claimed in claim 11 being further configured to identify at least one ad segment in the audio stream and substitute the at least one ad segment in the audio stream with a new ad segment retrieved from a database.

16. The system as claimed in claim 15 wherein the new ad segment is customized for a particular user by use of user affinity information.

17. The system as claimed in claim 11 being further configured to substitute at least one functional segment of the audio stream with a new functional segment.

18. The system as claimed in claim 11 being further configured to collect information on at effectiveness of advertisement segments in the audio stream.

19. A non-transitory machine-useable storage medium embodying instructions which, when executed by a machine, cause the machine to:
receive an audio stream via a subsystem of a vehicle;
scan the audio stream, by use of a data processor, to extract keywords, keyword phrases, or acoustic properties;
use the extracted keywords, keyword phrases, or acoustic properties to classify audio segments of the audio stream as content segments, advertising (ad) segments, or functional segments;
substitute, by use of the data processor, at least one audio segment of the audio stream with a new audio segment to generate a modified audio stream in real time; and
cause the modified audio stream to be rendered for a user.

20. The machine-useable storage medium as claimed in claim 19 wherein the audio stream includes at least one functional segment generated by a vehicle navigation system.
